(19) United States
(12) Patent Application Publication
(10) Pub. No.: US 2010/0310848 A1
(43) Pub. Date: Dec. 9, 2010

(54) METHOD FOR MANUFACTURING A NANOPOROUS ALUMINA BASED MATERIALS WITH CONTROLLED TEXTURAL AND PARTICLE SIZE AND NANOPOROUS OBTAINED BY SAID METHOD

(75) Inventor: Alfonso Garcia-Bennett, Uppsala (SE)

Correspondence Address: CONNOLLY BOVE LODGE & HUTZ LLP, 1875 EYE STREET, N.W., SUITE 1100, WASHINGTON, DC, 20006, US

(73) Assignee: Nanologica AB, Uppsala (SE)

(21) Appl. No.: 12/745,164

(22) PCT Filed: Nov. 30, 2007
(86) PCT No.: PCT/EP2007/063107

§ 371 Date: May 27, 2010

(51) Int. Cl. C01F 7/02

(52) U.S. Cl. 428/220; 423/625

(57) ABSTRACT

A method for the preparation of an inorganic porous oxide material, comprising the following steps:

a) dissolving an alumina precursor in a mixture of a non-aqueous solvent and an acid;
b) dissolving a pore agent in a non-aqueous solvent;
c) mixing together the solutions obtained in step a) and b);
d) adding a morphology controller to the reaction mixture of step c);
e) evaporating the reaction mixture of step d); and
f) removing the morphology controller and the pore agent from the product of step e).

The present invention relates to a method for the preparation of nanoporous materials with defined particle size and shape as well as pore size; in particular the present invention relates to a method for the preparation of nanoporous alumina and to the product obtained by said method.

The method according to the invention allows to prepare a nanoporous material that find a variety of applications, particularly in the field of the catalysis. Examples of important catalytic areas where the present invention may find uses are: Fischer-Tropsch catalysis, acid catalysis, fine chemical catalysis, as supports for hydrogenation catalysts, as desulphurization catalysts, and redox catalysis where alumina is commonly utilized as a porous support or additive to the active Molybdenum, cobalt and/or nickel catalyst. A further application of materials produced under the scope of this invention is their use as scavengers in catalytic or other type of chemical reaction where the nanoporous alumina has as main role the prevention of deactivation of the active catalyst due its filtering effect of impurities, carbon or non-carbon based.

It is well known particle size and shape largely affects the activity and selectivity of catalytic reactions as a result of controlled diffusion of reactants and products through the porous matrix and catalyst, or through a stabilization of the catalyst and is distribution towards sintering. It is also known that a large improvement in the stability and longevity of a catalyst can be achieved by carefully tailoring the morphological (shape and size) properties of nanoporous solids.

High surface-area materials with nanoscale dimensions are of special interest in applications where active site mediated chemical reactions play an important role, such as catalytic applications where a high contact area between reactants and catalyst is necessary in order to achieve high yield in a cost-effective manner.

Alumina is the most widely used catalytic support for advanced heterogeneous catalysis as a result of the high hydrothermal stability encountered in transition aluminas. Alumina based materials are in addition widely used in other applications such as adsorption, composite materials, in paint coatings and functional ceramics. Alumina particles with nanoscale dimensions are being studied with great interest from industrial and academic perspectives since the properties, surface and crystal structure of nanoparticles are size-dependent. In turn, the discovery of mesoporous materials has given rise to an increase in research in the field of porous solids due to the possibility to tune pore sizes with different porous structures, as well as particle size and shape. Mesoporous research has mainly concentrated in the use of preparation of porous silicas and their application, although several synthetic methods have been recently published on how to extent the mesoporous family to other oxide and metallic composition. In the case of mesoporous alumina, several sol-gel, and surfactant assisted routes have been reported. Huo et al. reported lamellar mesophases although these were thermally unstable. Using non-ionic surfactants under aqueous conditions Pinnavaia et al. achieved the synthesis of so called “wormhole” mesoporous alumina with a sharp pore distribution. Other synthesis have involved the use of anionic and cationic surfactants but these have led, generally to thermally unstable mesoporous structures post-removal of the surfactant through calcinations. Structurally speaking the most ordered structures were reported by Somorjai et al. using non-ionic surfactants where it was identified that the [H2O]:[Al3+] ratio influenced strongly the rate of hydrolysis of the alumina precursor and the textural properties pore size and surface area, of the final product.

The patent application PCT/JP02/05156, “Spherical Alumina Particles and production thereof”, describes a preparation method for the manufacture of “roundish” alumina particles having a mean particle size of 5-35 μm. This method comprises a step of granulation and a product of electro-fused alumina.

The patent application PCT/US2004/010266, “Nanoporous ultrafine alpha alumina powders and sol-gel process of preparing the same”, describes a method for the production of alumina powders where at least 80% of α-alumina particles have a mean size below 100 nm. The method produces alumina particles via hydrothermal treatment at typically 90° C. of an alumina precursor which may constitute an alumina alkoxide. The method also involves the formation of a gel which after hydrolysis is then treated at 800-900° C. in order to afford the α-alumina phase. The specific surface area of α-alumina particles produced is between 24-39 m2/g.

U.S. Pat. No. 5,728,184, “Method for making ceramic materials from boehmite”, discloses a method for making polycrystalline alpha alumina-based ceramic materials by forming a dispersion of boehmite and a silica source, hydrothermally treating the dispersion, converting the dispersion to an alpha alumina-based ceramic precursor material and sintering the precursor. Optionally, a nucleating material (sometimes referred to as a seed material) can be employed to reduce the size of the alpha alumina crystallites and enhance the density and hardness of the resultant ceramic material. This patent starts with boehmite and converts the boehmite to alpha alumina.

U.S. Pat. No. 4,073,718, “Process for the hydroconversion and hydrodesulphurization of heavy feeds and residua”, discloses a catalyst base of alumina stabilized with silica on which is deposited a cobalt or nickel catalyst.

U.S. Pat. No. 5,032,379, “Alumina suitable for catalytic applications”, discloses alumina having greater than 0.4 cc/g pore volume in the range 30 to 200 Angstroms pore diameter. It also discloses a catalyst containing gamma alumina but essentially no eta alumina, and a method of tailoring pore size distribution comprising bonding mixtures of particles of rehydration bondable alumina of different particle porosity.

J. Am. Ceram. Soc. 1998, 81 (6) 1411, “Size control of α-alumina particles synthesized in 1,-4 butanediol solution by α-alumina and α-hematite seeding”, describes control of the final particle size and shape through the use of alumina and iron oxide seeds in the synthesis of α-alumina. The final products are no-porous and there is no indication of the surface area of materials produced.

Advanced Materials, 1999, 11-(5) 379, “Surfactant-Assisted Synthesis of Mesoporous Alumina Showing Continuously Adjustable Pore Sizes”, reports the synthesis of mesoporous alumina, and the control of its pore size. No report on the morphological properties is included.

Chemical communications, 1998, 1185, “Rare earth stabilization of mesoporous alumina molecular sieves assembled through an N°I° pathway”, describes the preparation of MSU-x mesoporous Alumina samples and their thermal stability with addition of cerium and lanthanum ions. There is no controlled porosity in these samples, although they display very high surface areas, and there is no mention of morphological control.

Microporous and Mesoporous Materials 2000, 35-36 597, “Synthesis strategies leading to surfactant-assisted aluminas with controlled mesoporosity in aqueous media”, reports a variety of synthesis pathways leading to thermally stable mesoporous aluminum oxide phases, based on cooperative self-assembly of inorganic and surfactant species. All the mesostructured phases were obtained in aqueous media by hydrolysis and condensation. Most of the mesophases proved thermostable and exhibited a regular porous structure. Strongly depending on the synthesis and calcination conditions, their mean pore diameters vary between 8 and 60 Å and their specific surface areas range between 300 and 820 m2/g.

Nature, 1998, 396 (12) 152, “Generalized Syntheses for large pore mesoporous metal oxides with semicrystalline frameworks”, discloses a procedure for the synthesis of thermally stable, ordered, large-pore (up to 140 Å in alumina) mesoporous metal oxides. The synthesis is a non-aqueous sol-gel route, where the pore forming agent is a polymeric surfactant. However no control of the particle shape of size is reported.

It has now been found that inorganic porous oxide materials, in particular nanoporous alumina, can be prepared according to a process that allows to control the particle size and shape as well as the pore size and pore size distribution of the obtained product.

### BRIEF DESCRIPTION OF THE INVENTION

Thus, the present invention, in its more general definition, relates to a method for preparing inorganic porous oxide materials, in particular ordered mesoporous alumina, with and without dopants, with a sharp pore size distribution based on the use of non-ionic surfactants under acid and non-aqueous conditions. The invention includes the addition of co-surfactants or particle shape controllers in order to control the shape and size of nanoporous particles produced. The combination of porous properties and morphological shape renders the materials produced using this method unique.

In particular, in a first aspect the present invention relates to a method for the preparation of an inorganic porous oxide material which is characterized in that it comprises the following steps:

a) dissolving an alumina precursor in a mixture of a non-aqueous solvent and an acid;

b) dissolving a pore agent in a non-aqueous solvent;

c) mixing together the solutions obtained in step a) and b);

d) adding a morphology controller to the reaction mixture of step c);

e) evaporating the reaction mixture of step d); and

f) removing the morphology controller and the pore agent from the product of step e).

In a further aspect the present invention relates also to inorganic porous oxide material, in particular, mesoporous alumina, with and without dopants, obtainable from said method.

### DETAILED DESCRIPTION

The preparation route in order to form NPF-Al (nanoporous alumina) according to the present invention involves the formation of an acidified alumina sol, obtained by dissolution of a suitable alumina source in a mixture comprising a non-aqueous solvent and an aqueous acid solution. The pH of the reaction may vary between 0.5 and 2, preferably between 0.8 and 1.2, a typical value being around 0.9. Several alumina alkoxides have been tested and on the basis of preliminary results, ease of handling and cost, aluminium tri-sec-butoxide was deemed most suitable for the purpose of this project; however aluminium nitrate as well as other alumina alkoxides and salts of alumina may be employed, as described below. Best results are obtained using HCl as acid but textural control is also achieved when the acid employed is HNO3.

The clear alumina sol is then allowed to hydrolyze slowly at room temperature for a period of 1 hour, although this period may be lengthened to 80 hours.

Subsequently a suitable surfactant template in an ethanol-water solution (in the ratio of 10:1) is added to the alumina sol under low temperature conditions (20-40° C.) and under stirring. The surfactant solution may be mixed previous to addition to the alumina solution with an organic swelling agent in order to control the final pore size of the material produced. Suitable swelling agents include; mesitylene and decane. The clear solution is allowed to react for a period of 6-80 hours at 100° C. This step may be conducted in an autoclave or in a reflux condenser. During this period alumina further hydrolyses and interaction with the surfactant headgroup moieties occurs through hydrogen bonding. Suitable surfactants include the use of non-ionic surfactants however these may be replaced or used in combination with cationic surfactants, anionic surfactants or ordered mesoporous precursors, where the precursor is composed of an ordered self-assembled surfactant structure surrounded by a stable organosilane.

The sol is then submitted to an evaporation step. The rate and temperature of this step can be used to control the textural properties of the solid formed where faster evaporation rates lead to less defined morphologies and slower evaporation rates lead to more defined porous structures and morphologies. A flow of nitrogen or argon may be employed to control the evaporation rate of solvents from the alumina sol. The resulting slow increase in alumina concentration causes precipitation of the alumina precursor around the surfactant species and condensation. An increase in viscosity as further evaporation and precipitation occurs is observed leading to a gel like material that may be extruded or sprayed dried. After a period that may vary between 12 and 240 hours and dependent on the temperature of the evaporation step a white monolithic material is produced comprising; amorphous oxy-hydroxide species of alumina, the self-assembled surfactant, water, organic solvent not evaporated, and co-surfactants. The material may then be calcined under a flow of nitrogen and oxygen at between 300° C. and 1200° C. in a tube furnace in order to remove all organic material. The calcination temperature allows to select the final materials structural characteristics, whereby a calcination at 500° C. results in an amorphous alumina, calcination at between 600-800° C. results in a gamma-alumina phase, calcination at between 800-1000° C. results in a delta-alumina phase and calcination above 1000° C. results in an alpha-alumina phase.

Before the evaporation step a “morphology directing agent” is added to the reaction mixture and the solution stirred for a period of between 1 hour-5 hours. The morphology director may be contain surfactant species that should be not the same as that employed for the formation of the porous material. A typical director may be chosen from the family of surfactants known as the anionic amphiphile surfactants, and may include such species as Laurie acid, Palmitic acid or amino acid derived surfactant such as N-Lauroyl lysine. The morphology directing agent forms a liquid crystalline phase surrounding the evaporating alumina-pore forming agent mixture. As the concentration of the alumina increases, the morphology directing agent imposes its liquid crystalline structure on the growing particle, forming faceted particles related crystallographically to the morphology directing agent and not to the alumina or the pore forming agent.

The resulting phase is a high surface area amorphous alumina monolith with ordered mesopores structure porosity and controlled faceted particle shape and size as exemplified below.

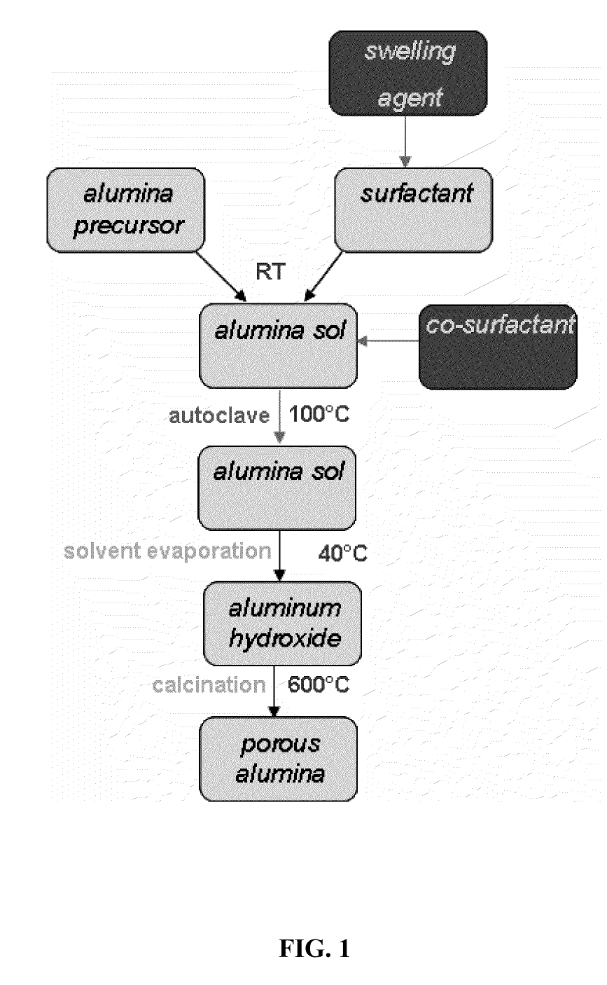

A schematic representation of the general synthesis procedure with some example of temperatures is shown FIG. 1. The overall process can be sub-divided into the following distinct Steps.

Step a).

The preparation of the alumina precursor involves the dissolution of the alumina source in a suitable mixture of a non-aqueous solvent and an acid. Suitable alumina precursors include aluminium nitrate, aluminium chloride, aluminium oxide, and the family of aluminium alkoxides of which aluminium sec-butoxide is an example. Suitable solvents should preferably have low boiling points. Ethanol is such a solvent but others may used such as acetone, propanol, butanol etc. Several acids have been employed such as hydrochloric acid, phosphoric acid, sulphuric acid and nitric acid. The final solution should have pH as close as possible to 1 and hence the amount of acid should be adjusted accordingly. The [H2O]:[Al3+] should be kept as close as possible to six in order to achieve a slow hydrolysis and condensation of the alumina hydroxide, and hence the concentration of the acid must be also adjusted accordingly. The solution prepared during this stage is vigorously stirred at room temperature in order to homogenize it.

Step b).

The preparation of the pore agent, typically a non-ionic polymeric surfactant of which di and tri-block co-polymers are typically employed, is conducted by dissolving at room temperature the surfactant in a suitable non-aqueous solvent. To this solution swelling agents may be added in order to increase the final pore size of the nanoporous solid produced. At this stage a dopant precursor may be added in the form of a metal soap, or may be added at later stages in the preparation. Metal oxide dopants utilized in this invention include the family of liquid crystals known as the metal soaps of which some examples are:

Magnesium myristate/laurate/stereate/palmitate/caprylate

Calcium myristate/laurate/stereate/palmitate/caprylate

Chromium myristate/laurate/stereate/palmitate/caprylate

Manganese myristate/laurate/stereate/palmitate/caprylate

Iron myristate/lauric/stereate/palmitate/caprylate

Cobalt myristate/laurate/stereate/palmitate/caprylate

Nickel myristate/laurate/stereate/palmitate/caprylate

Molybdenum myristate/laurate/stereate/palmitate/caprylate

Zinc myristate/laurate/stereate/palmitate/caprylate

Ruthenium myristate/laurate/stereate/palmitate/caprylate

Rhodium myristate/laurate/stereate/palmitate/caprylate

Silver myristate/laurate/stereate/palmitate/caprylate

Silicon myristate/laurate/stereate/palmitate/caprylate

The addition of this type of dopant increases the final pore size of the product, as well as its surface area through the formation of microporosity within the alumina walls of the final product material. The presence or absence of metal oxide dopants affects in turn also the stability and onset of phase transformations of transition aluminas, whereby higher onset temperatures of the transition between amorphous and gamma-alumina is observed for a nickel oxide-alumina porous material produced through the method described in this invention.

Step c).

The solution formed in steps a) and b) are mixed in a suitable container and stirred vigorously at room temperature.

Step d).

During step c), the addition of a morphology directing agent in the form of an anionic surfactant can take place. Some typical morphology directing agents utilized for this purpose are the anionic surfactants, more specifically the addition of N-lauroyl-amino acid derived surfactants have been utilized in this invention.

The mixture is further stirred at temperatures of between 80-150° C. for a period of between 10 and 36 hours in order to homogenize the reaction mixture and to prepare the mixture for evaporation in the next stage. The amount of time and temperature has a direct effect in the shape and size of the particles produced as well as the type of anionic morphology directing agent used as a morphology controller. This is as a result of the liquid crystal phase that the co-surfactant forms within which the alumina particle will grow at a later stage, as well as due to the formation of small alumina oxyhydroxide seeds at higher temperatures.

Step e).

After step d) has been completed the reaction mixture is allowed to cool before pouring into a large flat surface container in order for the evaporation of the solvent to proceed. The evaporation rate can be controlled through different means, including heating from 30-70° C. and or by passing a flow of air or a mixture of air-nitrogen, or an argon-nitrogen mixture. In the final stages of the evaporation in order to speed the rate of evaporation and eliminate as much as solvent as possible microwave drying may also be utilized as well as vacuum evaporation. The overall evaporation may also be performed without the aid of any gas at room temperature.

The evaporation step is particularly important for the formation of well ordered pores and defined particle shape. With very fast evaporation rates at temperatures above or around the boiling point of the solvent utilized, the formation of spheroid particles is observed.

Also, the resulting material has a pore size of between 30-100 Å depending on the temperature of evaporation employed and a surface area of approximately 200 m2/g. In order to increase the pore size swelling agents in the form of organic solvents such as for example mesitylene may be employed, giving porous systems with pore sizes as big as 300 Å. The swelling agent maybe added for instance at step a).

Step f).

The removal of the morphology controller and the pore forming agent as well as any co-surfactant that has been added in order to activate the inorganic oxide solid support or form the dopant oxide, can be conducted for instance by calcination at a temperature between 300-1200° C., in the presence of a suitable gas mixture, where said suitable gas is comprised typically of nitrogen and oxygen in different proportions. The heating rate and temperature of the calcination have distinct effects on the textural properties of nanoporous materials thus produced where properties such as surface area can be controlled in the range between 100-500 m2/g, pore volume in the range of 0.30-0.98 (and above) cm3/g, as well as pore size and pore size distribution. The removal of the organics through step f) is hence an important step of this process; however other methods such as solvent extraction and UV-irradiation have also been conducted and lead to porous materials of similar properties.

More importantly the control of morphology properties can be achieved, through the bottom-down approach described here, leading to porous materials with a variety of aspect ratios; sizes and shapes. Spherical particles with ranges between 0.5 and 10 μm in size have been prepared (see example section). The pore size of materials produced may be controlled from 4-30 nm through addition of swelling agents.

### EXAMPLES

### Example 1

### Preparation of Nanoporous Alumina with Cubic Morphologies

In a typical preparation 20.0 grams of triblock co-polymer P123 (EO₂₀PO₇₀EO₂₀, MW=5800) were dissolved in 150.0 ml of ethanol in a polypropylene bottle. To this solution a further 23.0 ml of mesitylene (trimethyl benzene, TMB) were added and the remaining surfactant solution was heated under stirring for 24 hours at 40° C., in order to ensure a homogeneous surfactant solution. In a separate polypropylene bottle, 30.0 ml of HCl (37%) were mixed with 92.0 ml of ethanol, to which 51.0 ml of aluminium-sec-butoxide was slowly added under rapid stirring, and allowed to stand at 40° C. for 24 hours to ensure full dissolution of the alumina source. The remaining clear solution was then added slowly to the surfactant solution at 40° C. under stirring, and after approximately 2 hours the required amount of N-lauroyl-lysine (C₁₂Lysine) was added. After complete dissolution of the co-surfactant the final synthesis gel was allowed to stand for a further 24 hours at 40° C. under slow stirring, before transferring it to a stainless steel Teflon lined autoclave and the gel treated at 100° C. for 48 hours. The final molar ration of the gel was P123:EtOH:TMB:HCl:H₂O:C₁₂H₂₇O₃Al:C₁₂Lysine; 0.017:22.73:0.82:1.79:6:1:x, where x has been varied between 0.5-1.5. The measured pH before the thermal treatment at 100° C. was 0.8 and did not rise on addition of the co-surfactant.

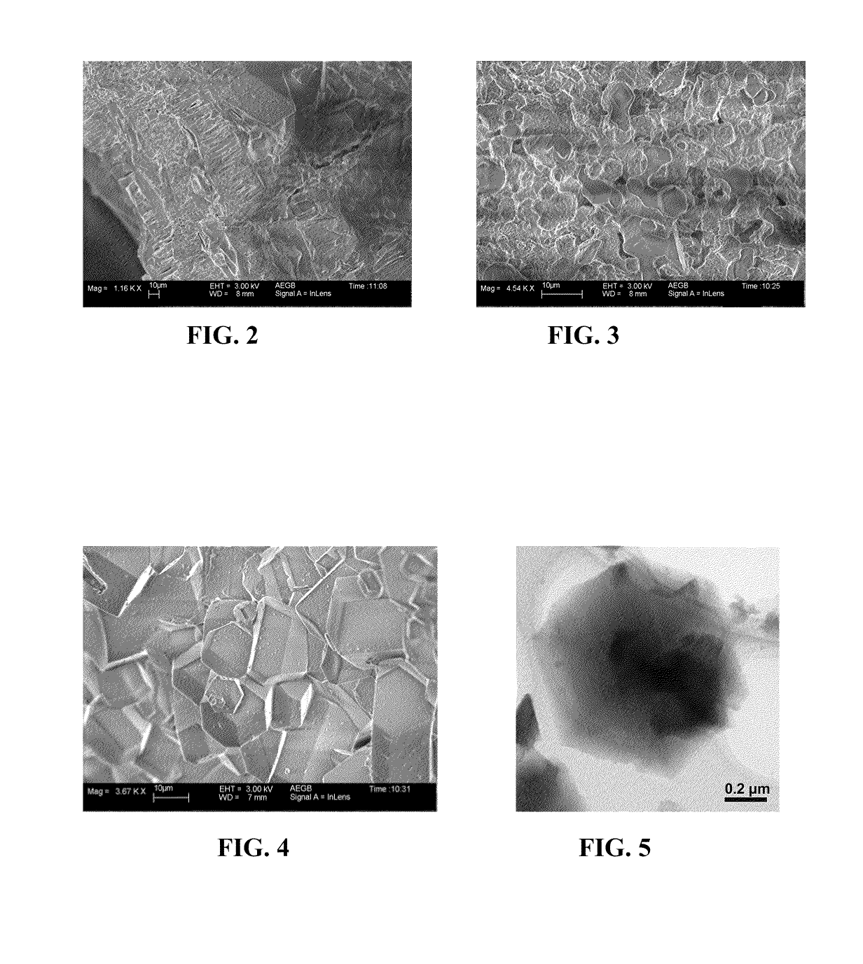

After the reaction had concluded the autoclaves were opened and the sample was allowed to slowly evaporate at 20° C. Finally the remaining mesostructured solid was calcined at 550° C. under flowing nitrogen for 6 hours followed by oxygen for a further 6 hours. Samples are denoted NPF-Al(x), where x demotes the molar ratio of C₁₂Lysine added to the synthesis gel. Typical SEM Images of calcined NPF-Al(0.5) and NPF-Al(0.8) are respectively shown in FIGS. 2 and 3, where the formation of amorphous morphologies is observed in the sample containing less morphology directing agent and the formation of distinct particles begins to appear in NPF-Al(0.8).

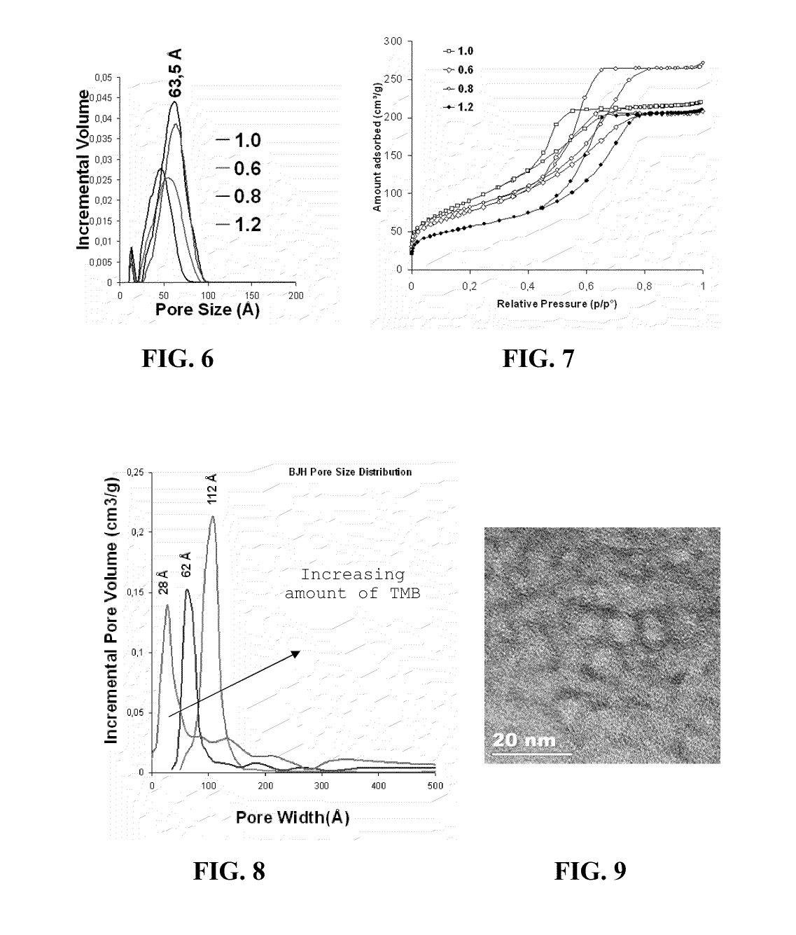

A typical SEM and TEM Image of NPF-Al(1) is respectively shown FIGS. 4 and 5, where cubic morphologies are clearly observed, with an average particle size of between 1-5 μm: The pore size distribution (BJH) and nitrogen adsorption isotherm plot of NPF-Al(x) are respectively shown in FIGS. 6 and 7, where the amount of morphology directing agent has been varied from 0.6-1.8. Typical Type IV adsorption curves for mesoporous materials are observed exemplified by a hysterisis loop on the desorption branch.

### Example 2

### Preparation of Nanoporous Alumina with Varying Pore Sizes

In a typical preparation 20.0 grams of triblock co-polymer P123 (EO₂₀PO₇₀EO₂₀, MW=5800) were dissolved in 150.0 ml of ethanol in a polypropylene bottle. To this solution mesitylene (trimethyl benzene, TMB) was added and the remaining surfactant solution was heated under stirring for 24 hours at 40° C., in order to ensure a homogeneous surfactant solution. In a separate polypropylene bottle, 30.0 ml of HCl (37%) were mixed with 92.0 ml of ethanol, to which 51.0 ml of aluminium-sec-butoxide was slowly added under rapid stirring, and allowed to stand at 40° C. for 24 hours to ensure full dissolution of the alumina source. The remaining clear solution was then added slowly to the surfactant solution at 40° C. under stirring, and after approximately 2 hours the required amount of N-lauroyl-lysine (C₁₂Lysine) was added. After complete dissolution of the co-surfactant the final synthesis gel was allowed to stand for a further 24 hours at 40° C. under slow stirring, before transferring it to a reflux condenser and the gel treated at 100° C. for 48 hours. The final molar ration of the gel was P123:EtOH:TMB:HCl:H₂O:C₁₂H₂₇O₃Al:C₁₂Lysine; 0.017:22.73:x:1.79:6:1:1, where x has been varied between 0.2-2. The measured pH before the thermal treatment at 100° C. was 0.3 and did not rise on addition of the co-surfactant. Finally the remaining mesostructured solid was calcined at 550° C. under flowing nitrogen for 6 hours followed by oxygen for a further 6 hours. Typical pore size distribution (PSD) curves of NPF-Al samples are reported in FIG. 8 showing higher pore sizes with increasing amounts of swelling agent. A typical TEM image of a NPF-Al sample with a PSD centered at 62 Å is in addition shown in FIG. 9 where cylindrical pores can be clearly discerned.

### Example 3

### Preparation of Nanoporous Alumina with Metal Soap Co-Surfactants

In a typical preparation 20.0 grams of triblock co-polymer P123 (EO₂₀PO₇₀EO₂₀, MW=5800) were dissolved in 150.0 ml of ethanol in a polypropylene bottle. To this solution a further 23.0 ml of mesitylene (trimethyl benzene, TMB) were added with the desired amount of nickel soap (nickel laurate), and the remaining solution was heated under stirring for 24 hours at 40° C., in order to ensure a homogeneous surfactant solution. In a separate polypropylene bottle, 30.0 ml of HCl (37%) were mixed with 92.0 ml of ethanol, to which 51.0 ml of aluminium-sec-butoxide was slowly added under rapid stirring, and allowed to stand at 40° C. for 24 hours to ensure full dissolution of the alumina source. The remaining clear solution was then added slowly to the surfactant solution at 40° C. under stirring, and after approximately 2 hours the required amount of N-lauroyl-lysine (C₁₂Lysine) was added. After complete dissolution of the co-surfactant the final synthesis gel was allowed to stand for a further 24 hours at 40° C. under slow stirring, before transferring it to a reflux condenser and the gel treated at 100° C. for 48 hours. The remaining gel was allowed to evaporate to completion before calcination as in the above examples.

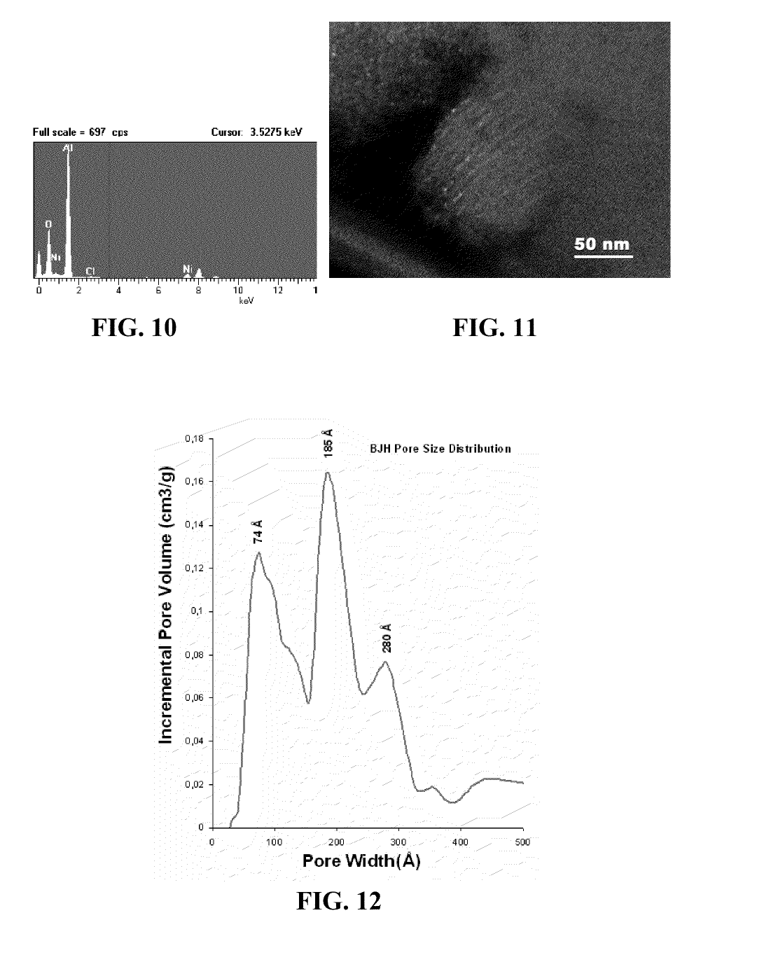

A typical EDAX spectra is shown in FIG. 10 indicating chemical analysis of a nanoporous alumina-nickel oxide particle. The Dark field image reported in FIG. 11 shows a homogeneous incorporation of nickel oxide particles inside the pores of the alumina support. The pore size distribution of this sample as derived from the nitrogen adsorption-desorption isotherm, with an Al/Ni ratio of 26 is reported in FIG. 12, showing the formation of extra pores associated with the self-assembly of the metal soap co-surfactant.

### Example 4

### Preparation of Nanoporous Alumina with Mixed Metal Soap Co-Surfactants

In a typical preparation 20.0 grams of triblock co-polymer P123 (EO₂₀PO₇₀EO₂₀, MW=5800) were dissolved in 150.0 ml of ethanol in a polypropylene bottle. To this solution a further 23.0 ml of mesitylene (trimethyl benzene, TMB) were added with the desired amount of nickel soap (nickel laurate), and molybdenum soap and the remaining solution was heated under stirring for 24 hours at 40° C. The alumina precursor was added and the remaining clear solution was then added slowly to the surfactant solution at 40° C. under stirring, and after approximately 2 hours the required amount of N-lauroyl-lysine (C₁₂Lysine) was added. After complete dissolution of the co-surfactant the final synthesis gel was allowed to stand for a further 24 hours at 40° C. under slow stirring, before transferring it to a reflux condenser and the gel treated at 100° C. for 48 hours. The remaining gel was allowed to evaporate to completion before calcination as in the above examples.

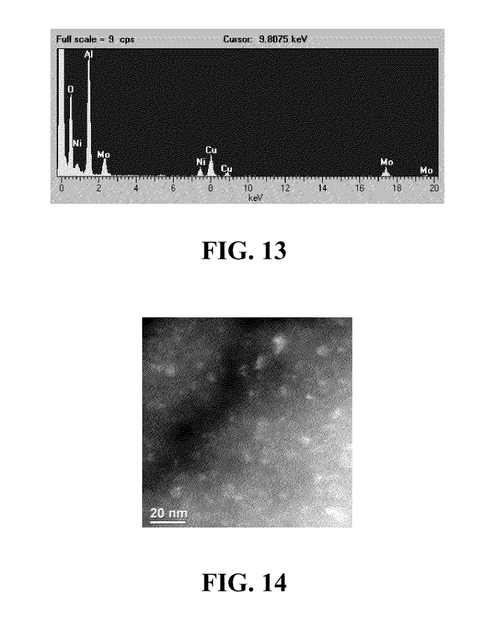

A typical EDAX spectra is shown in FIG. 13 indicating chemical analysis of a nanoporous alumina-nickel-molybdenum oxide particle. Atomic ratio as determined by EDAX analysis of this particular sample was: 1 Ni:3 Mo:29.6 Al.

The Dark field image reported in FIG. 14 shows a homogeneous incorporation of nickel and molybdenum oxide nanoparticles inside the pores of the alumina support.

The pore size distribution curve was calculated using the BJH method on the desorption branch of the Type IV isotherm and applying the Broekhoff-De Boer correction was centred at 107 Å. Surface area (SBET=160.4 m²/g) was calculated using the BET method and the Total pore volume (Tvol) is measured at a relative pressure of p/p°=0.98 and had a value of 0.45 cm³/g.

1. A method for the preparation of an inorganic porous oxide material, characterized in that it comprises the following steps:
a) dissolving an alumina precursor in a mixture of a non-aqueous solvent and an acid;
b) dissolving a pore agent in a non-aqueous solvent;
c) mixing together the solutions obtained in step a) and b);
d) adding a morphology controller to the reaction mixture of step c);
e) evaporating the reaction mixture of step d); and
f) removing the morphology controller and the pore agent from the product of step e).

2. The method of claim 1, characterized in that the pH of said step a) is between 0.5 and 2.0, preferably between 0.8 and 1.2.

3. The method of claim 1, characterized in that said alumina precursor is selected from aluminium nitrate, aluminium chloride, aluminium oxide, and aluminium alkoxides or a combination thereof.

4. The method of claim 3, characterized in that said alumina precursor is aluminium tri-sec-butoxide.

5. The method according to claim 1, characterized in that said pore agent is a non-ionic polymeric surfactant.

6. The method of claim 5, characterized in that said non-ionic polymeric surfactant is selected from di and tri-block co-polymers.

7. The method according to claim 1, characterized in that a metal oxide dopant precursor is added in the form of a metal soap during any of said stages from a) to d).

8. The method of claim 7, characterized in that said metal is selected from Magnesium, Calcium, Manganese, Iron, Cobalt, Nickel, Molybdenum, Zinc, Ruthenium, Rhodium, Silver, Silicon or combination thereof.

9. The method according to claim 1, characterized in that said morphology controller is an anionic surfactant.

10. The method of claim 7, characterized in that said anionic surfactant is a N-lauroyl-amino acid derived surfactant.

11. The method according to claim 1, characterized in that before the mixing step c) the solution obtained in step b) is mixed with an organic swelling agent.

12. The method of claim 7, characterized in that said organic swelling agent is selected form mesitylene and decane.

13. An inorganic porous oxide material obtainable form a method according to claim 1.

14. The inorganic porous oxide material of claim 13, characterized in that it has mesopores with a sharp pore size in the range of 1-30 nm.

15. The inorganic porous oxide material of claim 13, characterized in that it has a particle size in the range of between 100 nm and 200 μm.

16. The inorganic porous oxide material according to claim 13, characterized in that it has a spherical, flat particle, or facetted particles morphology.

17. The inorganic porous oxide material according to claim 13, characterized in that it has a flat shaped particle morphology, with thickness of equal to or larger than 1 μm.

18. The inorganic porous oxide material according to claim 13, characterized in that it has a surface area greater than 400 m2/g.

19. The method of claim 2, characterized in that said alumina precursor is selected from aluminium nitrate, aluminium chloride, aluminium oxide, and aluminium alkoxides or a combination thereof.

20. The method according to claim 2, characterized in that said pore agent is a non-ionic polymeric surfactant.
